(19) United States
(12) Patent Application Publication
(10) Pub. No.: US 2008/0119244 A1
(43) Pub. Date: May 22, 2008

(54) AESTHETIC AND PROTECTIVE CASE

(76) Inventor: Rohit Malhotra, Muttontown, NY (US)

Correspondence Address: ELLIOT FURMAN, 15 WEST 81ST STREET #11J, NEW YORK, NY, 10024, US

(21) Appl. No.: 11/562,837

(22) Filed: Nov. 22, 2006

(51) Int. Cl. H04M 1/02

(52) U.S. Cl. 455/575.1

(57) ABSTRACT

A case for a portable electronic device comprises a solid portion bonded to a pliable layer. The solid portion comprises a solid inner surface, a solid outer surface, and a solid edge. The pliable layer comprises a pliable inner surface, a pliable outer surface, and a pliable edge. The pliable layer is positioned over the solid portion so that the pliable edge and solid edge are aligned. A dye covers the pliable edge and the solid edge. The pliable layer comprises decoration.

### BACKGROUND

The pervasive use of portable electronic devices, such as cellular phones, Blackberries®, and other devices, has led to a need for protective carrying cases and pouches for such devices. Different types of cases are used to carry and protect portable electronic devices. Many of these cases are made from leather, cloth, PVC, Neoprene, or a combination of such materials. Telephone holders made of plastic or metal, are also used to protect cellular phones.

Use of one material over another for these cases provides selective advantages and disadvantages. For example, a case or a pouch made from a soft material allows a selection of aesthetically pleasing decorations, such as decorative stitching, and usually inexpensive alternatives relating to the case's overall appearance, but the case or the pouch does not offer nearly as much protection as a plastic or a metallic case. Indeed, the case or the pouch often provides only a single layer of protection to the portable electronic device.

On the other hand, a plastic or a metallic case generally offers better protection for an enclosed portable electronic device, but is also usually more expensive, and generally more difficult to decorate, or to render a more aesthetically pleasing appearance. For example, it is difficult if not impossible to incorporate decorative stitching with a plastic or metallic case.

When a case is made primarily of a soft material, the soft material tends to lose shape with usage of the case. This problem is exacerbated since the portable electronic device is frequently removed from and replaced into the case. For example, when a case made of a soft material is used for a cellular phone, frequent insertions into and removals from the case during normal use of the cellular phone may cause wear to surfaces of both the cellular phone and the case.

Cases also sometimes obstruct the functioning of folding and sliding types of portable electronic devices. Additionally, many cases are a loose fit for folding and sliding type phones and do not provide a compact, engineered look.

Accordingly, there is a need for a case that provides protection to a portable electronic device, while also allowing decorative embellishment, thus providing an aesthetically pleasing appearance. Furthermore, there is a need for such a case that can remain attached to the portable electronic device even when the device is being used, and which does not interfere with the normal use of the device.

### SUMMARY

In an aspect of the invention, a case for a portable electronic device is provided. The portable electronic device may include a cellular phone, a personal digital assistant, a digital music player, a portable communication device, and the like. The case comprises: at least one solid portion and at least one pliable layer. The solid portion comprises a solid inner surface, a solid outer surface, and a solid edge. The pliable layer comprises a pliable inner surface, a pliable outer surface, and a pliable edge. The pliable layer is positioned over the solid portion, such that, the pliable edge and solid edge are aligned. The solid outer surface is bonded to the pliable inner surface. The bonding may be done using an adhesive. Further, a dye is applied at an area adjacent to the solid edge and the pliable edge. The color of the dye may substantially match the color of the pliable layer. The solid portion and the pliable layer together provide dual protection to the portable electronic device. The solid portion of the case aids in retaining the shape of the case, while the pliable layer provides an aesthetic appearance to the case.

In another aspect of the invention, a case is provided for a portable electronic device. The case comprises a first unit and a second unit. The first unit comprises a first solid portion and at least one first pliable layer. The first solid portion comprises a first portion inner surface, and a first portion outer surface. The first portion inner surface and the first portion outer surface extend to form a first portion edge. The first pliable layer comprises a first layer inner surface and a first layer outer surface. The first layer inner surface and the first layer outer surface extend to form a first layer edge. The first portion outer surface is bonded to first layer inner surface such that the first portion edge and the first layer edge are substantially aligned. Similarly, the second unit comprises a second solid portion and at least one second pliable layer. The second solid portion comprises a second portion inner surface, and a second portion outer surface. The second portion inner surface and the second portion outer surface extend to form a second portion edge. The second pliable layer comprises a second layer inner surface and a second layer outer surface. The second layer inner surface and the second layer outer surface extend to form a second layer edge. The second portion outer surface is bonded to second layer inner surface such that the second portion edge and the second layer edge are substantially aligned. The first unit and the second unit of the case are combined, such that, the first portion edge is aligned with the second portion edge, and the portable electronic device is securely housed between the first and second unit.

The first solid portion and the second solid portion are usually made of a material comprising at least one of polypropylene, polypropylene copolymer, and co-polymers. The first pliable layer and the second pliable layer are made of a material comprising at least one of leather, vinyl, fabric, cloth, neoprene, and rubber. Further, the first pliable layer and the second pliable layer may comprise decoration such as stitching, beads, charms, embroidery, buckles, rivets, dyes, and insignias. The first solid portion and the second solid portion comprise clip-on means for snuggly and removeably attaching each portion to the portable electronic device. The case may further comprise a belt clip attached to at least one of the first solid portion and the second solid portion.

In yet another aspect of the invention, a method of forming a case for a portable electronic device is provided. A solid portion is molded. The solid portion comprises a solid inner surface, a solid outer surface, and a solid edge. In one embodiment, the molding further comprises molding the clip-on means on the solid inner surface and/or solid edge. The solid outer surface is then grinded and cleaned. A pliable layer is cut. The pliable layer comprises a pliable inner surface, a pliable outer surface, and a pliable edge. The solid outer surface which is substantially rough after grinding is bonded to the pliable inner surface using one of adhesive bonding, thermal bonding, and pressure bonding. For example, if the solid portion is plastic and the pliable layer is leather then the outer surface of the plastic is bonded to the inner surface of the leather using synthetic rubber contact adhesive. The bonding is done such that the solid edge and the pliable edge are substantially aligned. The solid edge and the pliable edge are then smoothened. The smoothened solid edge and the smoothened pliable edge are then sealed. Sealing comprises applying a dye over the solid edge and the pliable edge. The color of the dye may match the color of the pliable layer. Further, the pliable layer may be decorated.

### BRIEF DESCRIPTION OF THE DRAWINGS

FIG. 1A illustrates a perspective view of a case for a portable electronic device, in accordance with an embodiment of the present invention;

FIG. 1B illustrates an exploded perspective view of a case for a portable electronic device, in accordance with an embodiment of the present invention;

FIG. 1C illustrates a front view of a first unit of a case for a portable electronic device, in accordance with an embodiment of the present invention;

FIG. 1D illustrates a back view of a first unit of a case for a portable electronic device, in accordance with an embodiment of the present invention;

FIG. 1E illustrates a front view of a second unit of a case for a portable electronic device, in accordance with an embodiment of the present invention;

FIG. 1F illustrates a back view of a second unit of a case for a portable electronic device, in accordance with an embodiment of the present invention;

FIG. 2 illustrates a perspective view of a first unit of a case for a portable electronic device, in accordance with an embodiment of the present invention;

FIG. 3A illustrates a perspective view of an exemplary portable electronic device covered with a case for the portable electronic device, in accordance with an embodiment of the present invention;

FIG. 3B illustrates an exploded perspective view of an exemplary portable electronic device covered with a case for the portable electronic device, in accordance with an embodiment of the present invention;

FIG. 4 illustrates a back view of a case for a portable electronic device with a clip, in accordance with an embodiment of the present invention; and

FIG. 5 is a flowchart depicting a method of forming a case for a portable electronic device, in accordance with an embodiment of the present invention.

### DETAILED DESCRIPTION

In the following description, for purposes of explanation, specific numbers, materials and configurations are set forth in order to provide a thorough understanding of the invention. It will be apparent, however, to one having ordinary skill in the art, that the invention may be practiced without these specific details. In some instances, regular features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in an embodiment” in various places in the specification are not necessarily all referring to the same embodiment.

The present invention is a case for a portable electronic device which provides superior protection over soft cases and pouches, while also being aesthetically pleasing and easily decorated, such as by the addition of stitching. The portable electronic device may include a cellular phone, a personal digital assistant, a digital music player, a portable communication device, and the like.

In an embodiment, the case comprises at least one solid portion having a solid edge, and at least one pliable layer having a pliable edge. The pliable layer is positioned and bonded over the solid portion, such that, the pliable edge and solid edge are aligned. The solid portion and the pliable layer together provides two layer of protection to the portable electronic device. The solid portion of the case also retains the shape of the case, while the pliable layer also provides an aesthetic appearance to the case.

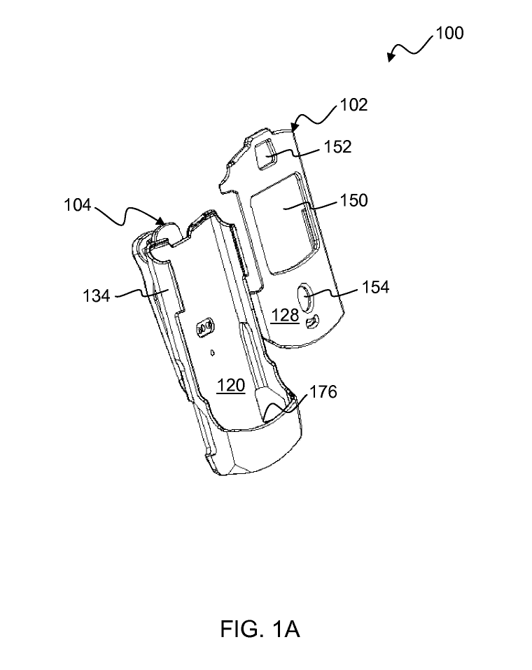

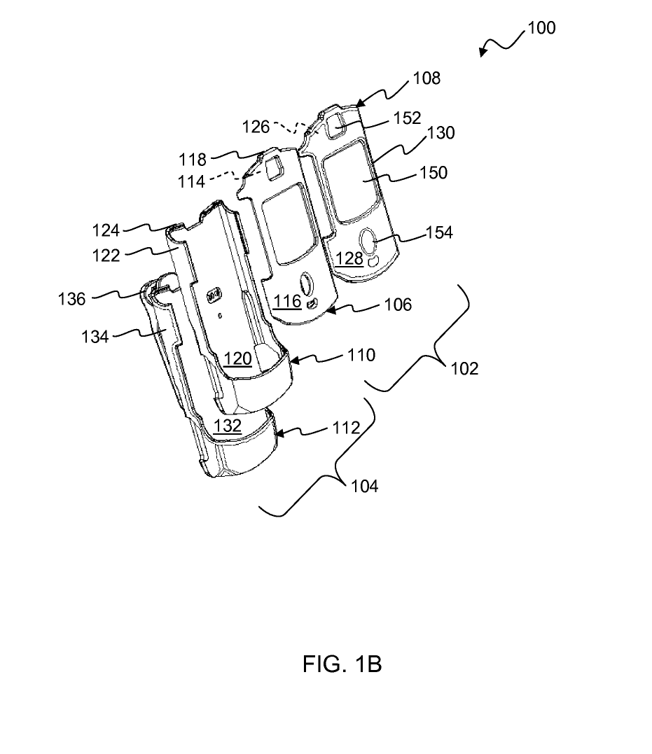

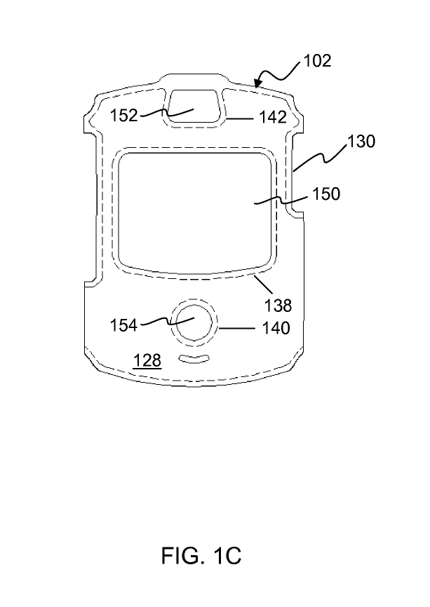

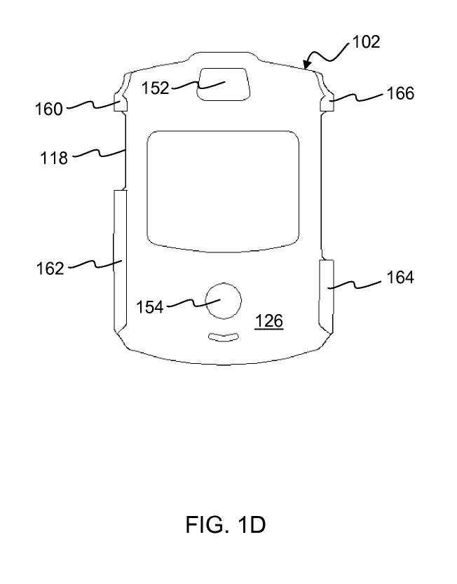

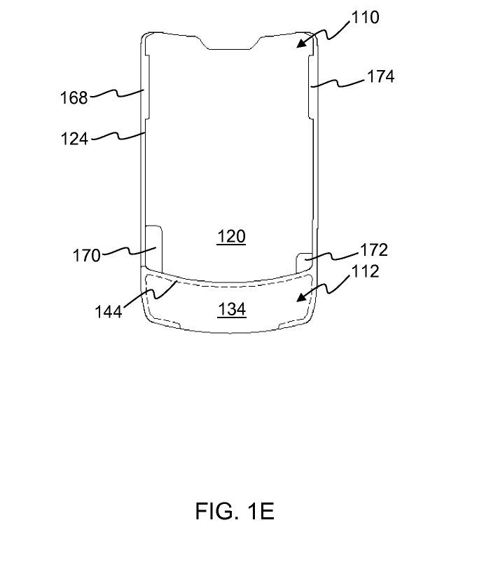

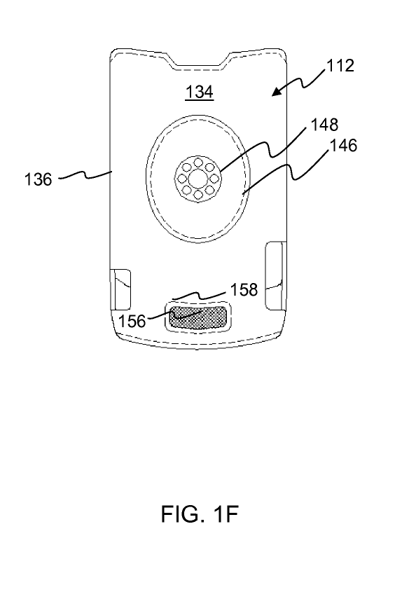

FIGS. 1A-1F depict various components and views of a case 100 for a portable electronic device in accordance with an embodiment of the present invention. As shown in FIG. 1A, the case 100 includes a first unit 102 and a second unit 104.

Turning now to FIG. 1B which shows an exploded view of the case, the first unit 102 includes a first solid portion 106, and a first pliable layer 108 positioned over the first solid portion 106. The second unit 104 comprises a second solid portion 110, and a second pliable layer 112 positioned over the second solid portion 110.

The first solid portion 106 includes a first portion inner surface 114 and a first portion outer surface 116. The first portion inner surface 114 and the first portion outer surface 116 extend to form a first portion edge 118. Similarly, the second solid portion 110 includes a second portion inner surface 120 and a second portion outer surface 122, which together extend to form a second portion edge 124.

In an embodiment of the invention, the first solid portion 106 and the second solid portion 110 comprise a material that provides significant structural integrity to the case 100. Exemplary materials usable for the first solid portion 106 and the second solid portion 110 include, but are not limited to, polypropylene, polypropylene co-polymer, and co-polymers. In addition, in an alternate embodiment the first solid portion 106 and the second solid portion 110 may each be made of a different suitable material.

The first pliable layer 108 includes a first layer inner surface 126, and a first layer outer surface 128, which together extend to form a first layer edge 130. Similarly, the second pliable layer 112 includes a second layer inner surface 132 and a second layer outer surface 134, which together extend to form a second layer edge 136.

In an embodiment of the invention, the first pliable layer 108 and the second pliable layer 112 are composed of a material that provides a soft feel and lends an overall aesthetically pleasing appearance to the case 100. Also, the material of the first and second pliable layers 108, 112 facilitates secure grasping of the portable electronic device, even, for example, with wet or greasy hands. Exemplary suitable materials for the first and second pliable layers 108, 112 include, but are not limited to, leather, vinyl, fabric, cloth, neoprene, velvet-like materials, and rubber. In addition, in an alternative embodiment, the first pliable layer 108 and the second pliable layer 112 may each be made of a different suitable material. In yet another embodiment, the first and second pliable layers 108, 112 may each comprise a plurality of sub-pliable layers, instead of one contiguous layer. The plurality of sub-pliable layers may be stitched together or bonded individually to the outer surface of a solid portion to form a contiguous pliable layer. Each sub-pliable layer may be made of a same or a different material.

The first layer inner surface 126 is bonded to the first portion outer surface 116, and the second layer inner surface 132 is bonded to the second portion outer surface 122. Bonding may be performed using any conventional bonding technique, such as but not limited to adhesive bonding, thermal bonding, or pressure bonding. For example, synthetic rubber contact adhesive may be used to bond the first layer inner surface 126 and the second layer inner surface 132 to the first portion outer surface 116 and the second portion outer surface 122, respectively.

In an exemplary embodiment of the invention, the first layer inner surface 126 may be bonded to the first portion outer surface 116, such that the first layer edge 130 and the first portion edge 118 are aligned. Similarly, the second layer inner surface 132 may be bonded to the second portion outer surface 122, such that the second layer edge 136 and the second portion edge 124 are also aligned.

While it is desirable that the first portion outer surface 116 and second portion outer surface 122 be sufficiently rough to promote effective bonding with the first layer inner surface 126 and the second layer inner surface 132, respectively, it is not necessarily required.

Similarly, although it is desirable that the first and second portion inner surfaces 114, 120 may be smooth to prevent wear to the portable electronic device from occasional insertions into and removals from the case, this is not necessarily required.

Further, the case 100 is designed such that a user can use and operate the portable electronic device even when the portable electronic device is in the case 100. As a result, surface wear to the portable electronic device is prevented since the case 100 need not be fitted and removed every time to use and operate the portable electronic device.

The first solid portion 106 and the second solid portion 110 provide a significant first level of protection for the portable electronic device. The first pliable layer 108 and the second pliable layer 112 provide a second level of protection for the portable electronic device, in addition to providing an aesthetically pleasing appearance, as described below.

Referring now to FIG. 1C, the first unit 102 may optionally include decorations or designs on at least one of the first pliable layer 108 or the second pliable layer 112, so as to provide an aesthetically pleasing appearance. Such decorations or designs may include stitching, beads, charms, embroidery, buckles, rivets, dyes, and insignias, and may be drawn, printed, or attached directly to the surface of the first unit 102 or otherwise applied thereupon. For example, the first pliable layer 108 may include stitching 138, 140 and 142, as shown in FIG. 1C.

In a similar manner, as shown in FIGS. 1E and 1F, the second pliable layer 112 may also include decorations, designs, or other accessories. For example, the second pliable layer 112 may include decorative stitching 144, 146. The first pliable layer 108 and the second pliable layer 112 may comprise different colors and materials. Also, the second solid portion may include an accessory such as a clip or clip attachment 148. One type of clip or clip attachments is a quick release swivel clip attachment, connected to the second solid portion 110 of the second unit 104.

The case may comprise cutouts, holes, notches, windows, apertures, slits, openings, and the like. For example, optionally, the first unit 102 of the case 100 comprises a viewing window 150 which, for example, may allow a user to view the display screen of a portable electronic device, even when the portable electronic device is enclosed in the case 100. The viewing window 150 may be in the form of a cut out in the first solid portion 106 and the first pliable layer 108. Alternatively, the viewing window 150 is an area of the first solid portion 106 visible through a cut out on the first pliable layer 108. In such cases, the first solid portion 106 may be made from a transparent material to allow viewing the display screen of the portable electronic device.

It is appreciated that the edge of any solid portion or pliable layer may include additional edges formed as a result of any cutouts, holes, notches, windows, apertures, slits, openings, and the like. Thus, it is understood that any discussion of any “edge” may include any or all additional edges. So, it is understood that a reference to “an edge” or “the edge” extends to any equivalent or additional edges.

In an embodiment of the invention, the first portion edge 118, the second portion edge 124, the first layer edge 130, and the second layer edge 136 is covered with a dye. The dyes used for these edges may comprise a single color or more than one color. Additionally, the dye comprises a color substantially matching a color of the first pliable layer 108 and the second pliable layer 112, and/or any sub-pliable layers. The dye also provides a third level of protection for a portable electronic device, as well as blending the solid portion edge with the pliable layer edge so that it appears to be one material.

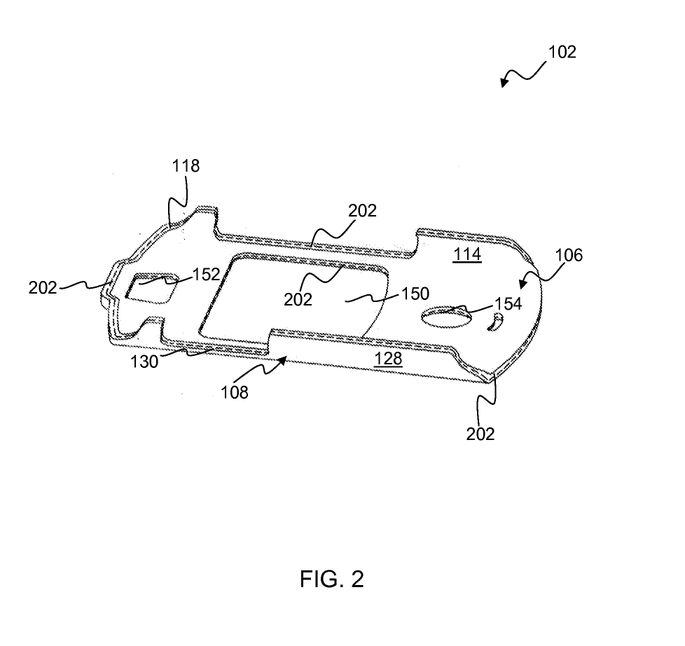

FIG. 2 illustrates a perspective view of an exemplary first unit 102 of the case 100 for a portable electronic device. A dye is applied on the first solid portion 106 and first pliable layer 108 at an area 202 adjacent to the first portion edge 118. The area 202 adjacent to the first portion edge 118 is the area where the first layer edge 130 meets the first portion edge 118. For example, a liquid dye, such as an edge dyer is applied, forming a permanent coat on the area 202. As shown in the FIG. 2, the area 202 adjacent to the first portion edge 118 includes the area where the first layer edge 130 meets the first portion edge 118 at the portions of the viewing window 150, the aperture 152, and the aperture 154.

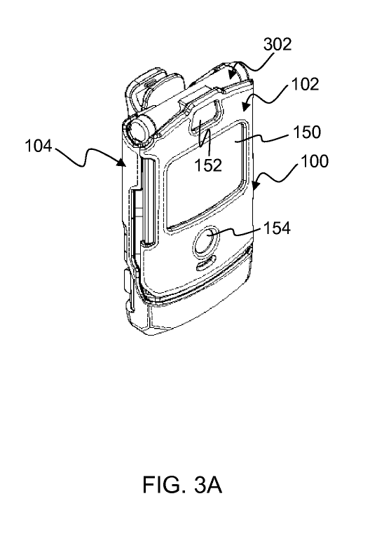

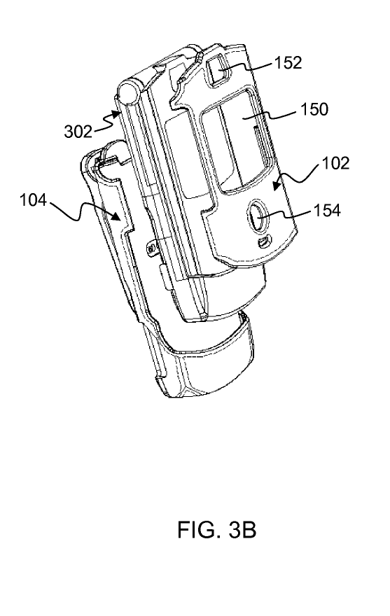

The first unit 102 and the second unit 104 combine for securely housing a portable electronic device. FIG. 3A depicts an exemplary portable electronic device 302, for example, a cellular phone, covered with an exemplary case 100. FIG. 3B illustrates an exploded perspective view of the portable electronic device 302 covered with the case 100. As shown in FIGS. 3A and 3B, the portable electronic device 302 is disposed between the first unit 102 and the second unit 104. The first unit 102 covers a first portion of the portable electronic device 302, and the second unit 104 covers a remaining portion of the portable electronic device 302.

In an embodiment of the invention, the first unit 102 covers the front of the portable electronic device 302 and the second unit 104 covers the back of the portable electronic device 302. At least one of first unit 102 and second unit 104 may further include one or more apertures that provide access to a charger port, an earphone/headphone port, a volume control, a camera, a speaker, and other ports and interfaces of the portable electronic device 302. An aperture may further provide a cosmetic purpose, and be otherwise unnecessary for providing access to ports and interfaces.

For example, as shown in FIG. 1C, the first unit 102 includes an aperture 152 for access to a camera lens of the portable electronic device 302, and an aperture 154 for cosmetic purpose. Apertures may be covered with plastic, screens, and other materials to provide protection to different portions of the portable electronic device, for example, a screen present on the portable electronic device, or the keypad of the portable electronic device. For example, as shown in FIG. 1F, a screen 156 covers an aperture 158. The aperture 158 may provide an access to a microphone. The screen 156 is bonded and held between the second solid portion 110 and the second pliable layer 112. In another example, a thin clear plastic may be used to cover an aperture.

Also, the first portion inner surface 114 of the first unit 102 and the second portion inner surface 120 of the second unit conform to the external shape of the portable electronic device 302. Additionally, the first and second unit 102, 104 comprise means for snuggly and removeably attaching each portion to portable electronic device 302. For example, the first portion 106 and the second solid portion 110 comprises clip-on means, such as, protrusions, plastic flexes, clips, and the like, around the first portion edge 118 and/or the second portion edge 124 and/or the first portion inner surface 114 and/or the second portion inner surface 120.

The first unit 102 of such an embodiment is depicted in FIG. 1D. In this example, the first solid portion 106 comprises clip-on means 160, 162, 164, 166. Clip-on means 160, 162, 164, 166 of first solid portion 106 releaseably engages a portion of the portable electronic device 302. More specifically, the first solid portion 106 may be mounted on the portable electronic device 302 and retained on the portable electronic device 302 by the gripping achieved from the sides provided by clip-on means 160, 162, 164, 166.

As shown in FIG. 1E, the second solid portion 110 includes clip-on means 168, 174. Additionally, the second solid portion 110 may be configured to include a pocket 176 as shown in FIG. 1A. The clip-on means 168, 174 may be widened by applying pressure, such as by a user's thumb and fingers, or by pressing the portable electronic device to the clip-on means. More specifically, the portable electronic device is slid into pocket 176 and the clip-on means 168, 174 widened to receive the portable electronic device. Once the pressure is released, the second solid portion 110 is then retained onto the portable electronic device by the gripping achieved from the sides provided with clip-on means 168, 174.

As shown in FIGS. 3A and 3B, the portable electronic device 302 may be a cellular phone, more specifically, a folding type cellular phone 302. The case 100 is designed such that a user can use and operate the cellular phone 302 even when the cellular phone 302 is in the case 100. In various embodiments of the invention, the cellular phone 302 may be a folding cellular phone, a bar mobile phone, or a sliding phone. The first unit 102 may be used to protect the keypad of cellular phone 302, or the keypad may alternatively be exposed. At least one of the first solid portion 106 and the second solid portion 110 may further comprise one or more apertures that provide access to ports and interfaces of the cellular phone 302 for recharging a battery, or for connecting an accessory, such as a hands-free lead. The case 100 may also be provided with additional apertures to enable parts of the cellular phone 302 to extend there-through, for example, an extendable antenna. The first portion inner surface 114 and the second portion inner surface 120 conform to the external shape of the cellular phone 302.

The case 100 may be specific to a particular model of cellular phone 302. Accordingly, the case 100 may have a different shape, size, and configuration to cover different models of the cellular phone 302, and, generally, to cover different portable electronic devices 302.

In an embodiment of the invention, the case 100 is provided with at least one clip to enable a user to attach the portable electronic device 302 encased in the case 100 onto a carrying belt or to a purse string, or the like.

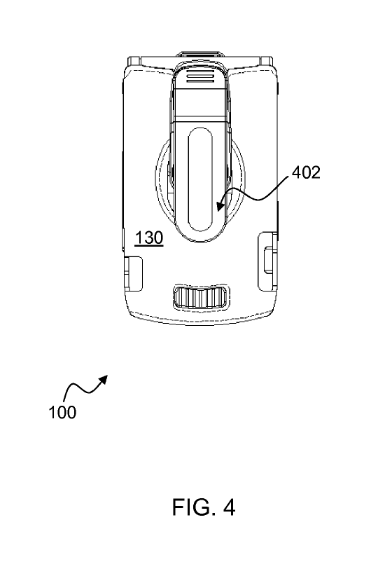

FIG. 4 illustrates a back view of an exemplary case 100 for a portable electronic device with a clip 402. In an embodiment of the invention, the second solid portion 110 comprises the clip 402, and the clip 402 may be an integral part of second unit 104. Alternatively, the clip 402 may be removeably attached on the second unit 104. Optionally, the second unit 104 comprises a slot or other type of mount or attachment point. The clip 402 is fitted in the slot and may be removed. The clip 402 may be made of a material comprising at least one of polypropylene, polypropylene copolymer, and other co-polymers. The clip 402 may comprise a swivel clip that can rotate.

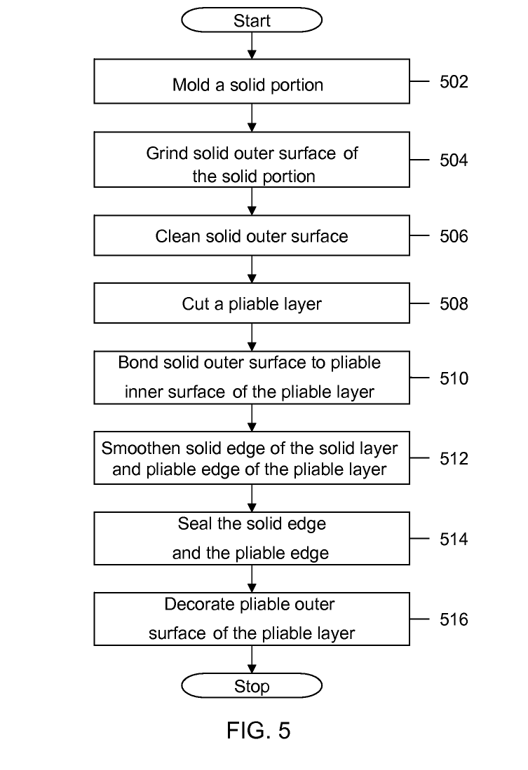

FIG. 5 is a flowchart illustrating an exemplary method of forming a case for a portable electronic device. In accordance with an embodiment of the invention, at step 502, a solid portion is molded. The solid portion comprises a solid inner surface, a solid outer surface and a solid edge. For example, the solid portion may be a plastic portion, and may be formed with an integral clip, or a clip attachment point. At step 504, the solid outer surface is grinded to make the solid outer surface rough. Grinding prepares the solid outer surface for enhanced bonding. At step 506, the solid outer surface is cleaned to remove abrasive particles. At step 508, a pliable layer is cut to match the shape of the solid outer surface. The pliable layer comprises a pliable inner surface, a pliable outer surface, and a pliable edge. Cutting may further include cutting apertures. At step 510, the solid outer surface is bonded to the pliable inner surface. The bonding is done using one of adhesive bonding, thermal bonding, and pressure bonding. In some embodiments, more than one type of bonding may be used. The solid outer surface is bonded to the pliable inner surface such that the solid edge and the pliable edge are substantially aligned. At step 512, the solid edge and the pliable edge are smoothened. In smoothening, the solid edge and the pliable edge are aligned by cutting, sanding, grinding, buffing, and the like such that there is substantially no overlap. Smoothening removes excess material, and smoothens out bumps, nicks, irregularities, and the like. At step 514, the solid edge and the pliable edge are sealed. Sealing comprises applying a dye over the solid edge and the pliable edge. In an embodiment of the invention, the color of the dye matches the color of the pliable layer. At step 516, the pliable outer surface is decorated. Decorating the pliable outer surface comprises sewing stitches through the pliable outer surface, attaching beads to the pliable outer surface, coloring the pliable outer surface, attaching charms to the pliable outer surface, embroidering the pliable outer surface, attaching rivets to the pliable outer surface, and marking insignias on the pliable outer surface. It is noted that the step of decorating 516 may be performed at any point in the process, depending on the type of decoration. For example, stitching is usually sewed before bonding 510 and may be done before or after cutting 508. Coloring may be performed before or after bonding 5 10. A second case portion, or additional case portions are formed by repeating the steps 502 to 516.

In an embodiment of the invention, a pliable layer such as leather is bonded onto the solid portion such as a plastic shell with a bonding adhesive. The plastic shell may be made of Polypropylene Copolymer (PPCP), and is first molded, and then the outer surface of the plastic shell is made rough by grinding to prepare it for enhanced bonding with the leather. Prior to bonding, the plastic shell is shiny and smooth and any bonding with leather would be relatively weak. Next, the ground surface is cleaned to remove plastic and abrasive particles from the surface. Then, the designed cut leather is bonded onto the plastic shell by applying bonding adhesive to the cleaned ground surface, the designed cut leather, or both. The raw edges of the leather may then be smoothened by pressing them against buffing wheel, and the final finish is obtained by using emery or sand paper. The edges of leather and plastic shell are coated with a liquid to match the leather edges on to plastic shell edge. In an embodiment of the invention, the liquid used is an edge dyer. The liquid forms a permanent coat.

In the foregoing description, specific embodiments of the present invention have been described by way of examples with reference to the accompanying figures and drawings. One of ordinary skill in the art will appreciate that various modifications and changes may be made to the embodiments without departing from the scope of the present invention as set forth in the claims below. Accordingly, the specification and figures are to be regarded in an illustrative rather than a restrictive sense, and all such modifications are intended to be included within the scope of the present invention.

The foregoing detailed description has set forth a few of the many forms that this invention can take. It is intended that the foregoing detailed description be understood as an illustration of selected forms that the invention can take and not as a limitation to the definition of the invention. It is only the following claims, including all equivalents that are intended to define the scope of this invention.

What is claimed is:

1. A case for a portable electronic device, comprising:
a solid portion comprising a solid inner surface, a solid outer surface, and a solid edge; and
a pliable layer comprising a pliable inner surface, a pliable outer surface, and a pliable edge, wherein the pliable layer is positioned over and bonded to the solid portion, such that, the pliable edge and the solid edge are aligned.

2. The case of claim 1 further comprising an adhesive bonding the solid outer surface to the pliable inner surface.

3. The case of claim 2 wherein the adhesive comprises a synthetic rubber contact adhesive.

4. The case of claim 1 further comprising a dye covering the pliable edge and the solid edge.

5. The case of claim 4 wherein the dye comprises a color substantially matching a color of the pliable layer.

6. The case of claim 1 further comprising a decoration on the pliable outer surface.

7. The case of claim 6 wherein the decoration comprises at least one of stitching, beads, charms, embroidery, buckles, rivets, dyes, and insignias.

8. The case of claim 1 wherein the solid inner surface is smooth and the solid outer surface is rough.

9. The case of claim 1 wherein the solid portion comprises at least one of polypropylene, polypropylene co-polymer, and a co-polymer.

10. The case of claim 1 wherein the solid portion comprises clip-on means for releaseably engaging the portable electronic device.

11. The case of claim 1 wherein the pliable layer comprises at least one of leather, vinyl, fabric, cloth, neoprene, and rubber.

12. The case of claim 1 further comprising a belt clip attached to the solid portion.

13. The case of claim 1 wherein the portable electronic device comprises at least one of a cellular phone, a personal digital assistant, a digital music player, and a portable communication device.

14. The case of claim 1 wherein the solid portion and the pliable layer further comprises one or more apertures.

15. The case of claim 1 wherein the pliable layer comprises a plurality of sub-pliable layers.

16. A case for a portable electronic device, comprising:
a first unit comprising,
a first solid portion comprising a first portion inner surface and a first portion outer surface, the first portion inner surface and the first portion outer surface extending to form a first portion edge;
at least one first pliable layer comprising a first layer inner surface and a first layer outer surface, the first layer inner surface and the first layer outer surface extending to form a first layer edge, and the first layer inner surface bonded to the first portion outer surface;
a second unit comprising,
a second solid portion comprising a second portion inner surface and a second portion outer surface, the second portion inner surface and the second portion outer surface extending to form a second portion edge; and
at least one second pliable layer comprising a second layer inner surface and a second layer outer surface, the second layer inner surface and the second layer outer surface extending to form a second layer edge, and the second layer inner surface bonded to the second portion outer surface;
wherein the first unit and the second unit of the case are combined, such that, the first portion edge is aligned with the second portion edge, for securely housing the portable electronic device therebetween.

17. The case of claim 16 wherein the first unit releaseably engages a front of the portable electronic device, and the second unit releaseably engages a back of the portable electronic device.

18. The case of claim 16 wherein the first unit covers a first portion of the portable electronic device, and the second unit covers a remaining portion of the portable electronic device.

19. The case of claim 16 wherein the first pliable layer and the second pliable layer comprise at least one of leather, vinyl, fabric, cloth, neoprene, and rubber.

20. The case of claim 16 wherein the first solid portion and the second solid portion comprise at least one of polypropylene, polypropylene co-polymer, and a co-polymer.

21. The case of claim 16 wherein the first pliable layer and the second pliable layer are bonded to the first portion outer surface and the second portion outer surface respectively using at least one of adhesive bonding, thermal bonding, and pressure bonding.

22. The case of claim 16 wherein the first pliable layer and the second pliable layer are bonded to the first portion outer surface and the second portion outer surface respectively with a synthetic rubber contact adhesive.

23. The case of claim 16 wherein at least one of the first pliable layer and the second pliable layer comprises at least one of stitching, beads, charms, embroidery, buckles, rivets, dyes, and insignias.

24. The case of claim 16 wherein the first portion edge, the second portion edge, the first layer edge, and the second layer edge are covered with a dye.

25. The case of claim 16 wherein the first portion inner surface and the second portion inner surface are smooth and the first portion outer surface and the second portion outer surface are rough.

26. The case of claim 16 further comprising at least one clip disposed on at least one of the first unit and the second unit.

27. The case of claim 16 wherein at least one of the first pliable layer and the second pliable layer comprises a plurality of sub-pliable layers.

28. A case for a portable electronic device, comprising:
a solid portion comprising a solid inner surface, a solid outer surface, and a solid edge;
a pliable layer comprising a pliable inner surface, a pliable outer surface, and a pliable edge, wherein the pliable layer is positioned over the solid portion, such that, the pliable edge and the solid edge are aligned;
an adhesive bonding the solid outer surface to the pliable inner surface;
a dye covering the pliable edge and the solid edge; and
a decoration on the pliable outer surface.

29. The case of claim 28 wherein the adhesive comprises a synthetic rubber contact adhesive.

30. The case of claim 28 wherein the dye comprises a color substantially matching a color of the pliable layer.

31. The case of claim 28 wherein the decoration comprises at least one of stitching, beads, charms, embroidery, buckles, rivets, dyes, and insignias.

32. The case of claim 28 wherein the solid inner surface is smooth and the solid outer surface is rough.

33. The case of claim 28 wherein the solid portion comprises at least one of polypropylene, polypropylene co-polymer, and a co-polymer.

34. The case of claim 28 wherein the solid portion comprises clip-on means for releaseably engaging the portable electronic device.

35. The case of claim 28 wherein the pliable layer comprises at least one of leather, vinyl, fabric, cloth, neoprene, and rubber.

36. The case of claim 28 further comprising a belt clip attached to the solid portion.

37. The case of claim 28 wherein the portable electronic device comprises at least one of a cellular phone, a personal digital assistant, a digital music player, and a portable communication device.

38. The case of claim 28 wherein the solid portion and pliable layer further comprises one or more apertures.

39. The case of claim 28 wherein the pliable layer comprises a plurality of sub-pliable layers.

40. A method of forming a case for a portable electronic device, comprising:
molding a solid portion, the solid portion comprising a solid inner surface, a solid outer surface, and a solid edge;
grinding the solid outer surface;
cleaning the solid outer surface;
cutting a pliable layer, the pliable layer comprising a pliable inner surface, a pliable outer surface, and a pliable edge;
bonding the solid outer surface to the pliable inner surface, such that, the solid edge and the pliable edge are substantially aligned;
smoothening the solid edge and the pliable edge; and
sealing the smoothened solid edge and the smoothened pliable edge.

41. The method of claim 40 wherein the sealing comprises applying a dye over the solid edge and the pliable edge.

42. The method of claim 40 further comprising decorating the pliable outer surface.

43. The method of claim 42 wherein the decorating comprises at least one of: sewing stitches through the pliable outer surface, attaching beads to the pliable outer surface, coloring the pliable outer surface, attaching charms to the pliable outer surface, embroidering the pliable outer surface, attaching rivets to the pliable outer surface, and marking insignias on the pliable outer surface.

44. The method of claim 40 further comprising forming a second case portion by repeating molding, grinding, cleaning, cutting, bonding, smoothening and sealing.

45. The method of claim 40 wherein the bonding comprises at least one of adhesive bonding, thermal bonding, and pressure bonding.
